(19) United States
(12) Patent Application Publication
(10) Pub. No.: US 2002/0159483 A1
(43) Pub. Date: Oct. 31, 2002

(54) SDH/SONET frame byte alignment unit

(75) Inventor: Rolf Clauberg, Gattikon (CH)

Correspondence Address: IBM CORPORATION, Intellectual Property Law, T.J. WATSON RES. CENTER, P.O. BOX 218, YORKTOWN HGTS, NY, 10598, US

(73) Assignee: International Business Machines Corporation, Armonk, NY

(21) Appl. No.: 10/123,797

(22) Filed: Apr. 12, 2002

(30) Foreign Application Priority Data
Apr. 26, 2001 (EP) 01110295.1

(51) Int. Cl. H04J 3/06

(52) U.S. Cl. 370/503

(57) ABSTRACT

The present invention relates to a method and device for creating an aligned outgoing data stream of a predetermined width and clock rate from an unaligned incoming data stream, particularly, for creating a several byte wide parallel data stream fully aligned to a SDH/SONET frame. The device according to the present invention comprises a storage unit for storing at least one bit times the width of the outgoing data stream, an align position detection unit for locating a particular bit position indicative of an align position, and

an output port for outputting the outgoing data stream, whereby said storage device is formed by a shift register providing storage space for at least two times the width of the outgoing data stream and an extracting unit is provided for forwarding as many bits as the width of the outgoing data stream starting from the located align position. Preferably, the shift register moves its contents per clock by as many bits as the width of said outgoing data stream. In a preferred embodiment, the device further comprises a demultiplexing unit for composing a data stream of a higher width than the incoming data stream. Hence, the incoming data stream can advantageously be performed by using a lower clock than the clock of the incoming data stream. Furthermore, while aligning the incoming data a parallel data stream of a larger width is formed for further processing.

### FIELD OF THE INVENTION

The present invention relates to a method and a device for creating an aligned outgoing data stream of a predetermined width and clock rate from an unaligned incoming data stream. Particularly, the present invention relates to a method and a device that creates a several byte wide parallel data stream fully aligned to a SDH/SONET frame.

### DESCRIPTION OF THE RELATED ART

The American National Standards Institute has established a standard for high-speed, multiplexed digital data transmission. This is the “synchronous optical network” standard, henceforth referred to as SONET. The SONET standard specifies optical interfaces, data rates, operation procedures and frame structures for multiplexed digital transmission via fiber optic networks.

The International Telecommunications Union (ITU) has adopted the Interface principles of SONET and recommended a new global transmission standard for high-speed digital data transmission. This standard is the “synchronous digital hierarchy” (SDH).

For an account of the SDH standard, reference should be made to the report 30 entitled “REPORT OF Q.22/15 MEETING” from “STUDY GROUP 15” of the ITU International Telecommunication Standardization Sector, bearing the document number “Temporary Document 62(3/15)” and the date “Geneva, May 16-27, 1994.”

The SDH standard is designed to enable manufacturers to develop telecommunications equipment which:

a) will be interchangeable in all telecommunication networks built around the world to its standard; and which

b) is backwards compatible, i.e. can be used with data which is in the older telecommunications formats used in North America, Europe and Japan.

An SDH frame according to the standard, e.g., consists of octet-oriented synchronous transport modules STM-1 with a bit rate of 155,520 kbits/s. The frame consists of 270 columns containing 9 rows each. 9×9 octets are dedicated to a so-called section overhead SOH, and 261×9 octets to a useful-information part, called “payload”.

Row 1 of the section overhead SOH contains a frame sync word with a length of 6 octets. Row 4 of the section overhead contains an administration unit pointer AU-4 PTR which addresses a path overhead POH of a virtual container VC-4 of the payload. The path overhead POH contains an additional pointer H4 which addresses cell headers of a 260×9-octet cell-structured container C4. The cell structure of the container allows the asynchronous transmission of data in the form of, e.g., ATM cells (asynchronous transport modules) within a synchronous frame (SDH).

In U.S. Pat. No. 5,251,239 a method is disclosed for synchronizing a system frame-structured in accordance with a digital synchronous hierarchy (SDH). In a hunt mode, one frame sync word is detected, and then a first pointer (AU-4) is read which is spaced a predetermined distance from the sync word and addresses a cell-structured data area (VC-4). Then the headers of the ATM (Asynchronous Transfer Mode) cells in the data area, which are addressed via the pointer, are decoded, and if x successive correct cell headers are decoded, a transition to the sync state takes place. If data structures of an SDH system or a purely cell-structured transmission of ATM cells have to be identified, an incoming bit sequence is checked for a predetermined frame sync word (SDH frame) and then for code words representing regularly inserted cell headers, and a change to either a frame sync mode or a cell sync mode takes place.

From U.S. Pat. No. 5,963,564 a link control function is known. The link control function includes a series/parallel converting and sync cell aligning function, a cell analyzing function, a sync state machine, a sync cell aligning function, a clock generator and a parallel/series converter. On the link between a switch port and the switch core a bit stream signal and a bit clock signal are transferred in each direction. S/P (Serial/Parallel) converter and sync cell alignment function receives the bit stream and converts it to bits parallel data that is admitted as a word stream to the cell analyzing function. Always when a state HUNT is true for the sync state machine it emits a hunt signal to the S/P converter and sync cell alignment function that forces the later to hunt a sync cell pattern for each bit position. When this pattern has been found the function emits a sync agreement signal to the sync state machine and a sync start signal to the cell analyzing function. The sync agreement signal forces the sync state machine to a state PRESYNC and deactivates the hunt signal. The sync start signal that is only active when the hunt signal is active, indicates to the cell analyzing function that a sync cell has been found. The S/P converter and sync cell alignment function now passes to a parallel mode and clocks the incoming bit stream word by word. Each word is indicated by a word clock signal to the cell analyzing function. The S/P converter and sync cell alignment function emits the sync agreement signal to the sync state machine each time it identifies a sync pattern. The cell analyzing function contains an internal cell size counter that it starts when it receives the sync start signal. The counter is clocked by the word clock signal. When the cell size has been counted down the cell analyzing function emits to the sync state machine a new cell signal that indicates that a new cell is expected. The cell analyzing function studies the new cell to see if it has an accepted format in the size field. A non accepted code results in transmission of an error signal to the sync state machine. The error signal forces the sync state machine to the state HUNT.

As aforementioned in SDH/SONET systems the data are transmitted as serial bit streams between network elements. When data is received from the physical line the first step is done by a deserializer element which transforms the serial data into a byte or several byte wide data stream. Commercial deserializer units for STM-4/4c (OC-12/12c) systems create a byte parallel data stream plus a frame alignment pulse correlated with a specific byte of the SDH/SONET overhead, normally the first or second A2 byte of the A1-A2 byte recognition pattern of the SDH/SONET frame. However, for higher transmission speeds like STM-12/12c (OC-48/48c) or STM-64/64c (OC-192/192c) state of the art deserializer units create no longer byte wide parallel data streams but data path of at least 16-bit (2 byte) width and without a SDH/SONET frame alignment pulse.

Those deserializers simply demultiplex the incoming serial data stream into a 16-bit wide parallel data stream without checking the correlation of the data stream with the SDH/SONET frame. Hence, any SDH/SONET framer device which wants to use such deserializer components has to perform the corresponding byte alignment with the SDH/SONET frame itself

### OBJECT OF THE INVENTION

Starting from this, the object of the present invention is to provide a method and a device for efficiently creating an aligned outgoing data stream of a predetermined width and clock rate from an unaligned incoming data stream.

### BRIEF SUMMARY OF THE INVENTION

The foregoing object is achieved by a method and a system as laid out in the independent claims. Further advantageous embodiments of the present invention are described in the sub claims and are taught in the following description.

According to the present invention a method and a device is provided for creating an aligned outgoing data stream of a predetermined width and clock rate from an unaligned incoming data stream. The respective device according to the present invention comprises a storage device for storing at least one bit times the width of the outgoing data stream, an align position detection unit for locating a particular bit position indicative of an align position, and an output unit for outputting the outgoing data stream, whereby said storage device is formed by a shift register providing storage space for at least two times the width of the outgoing data stream and an extracting unit is provided for forwarding as many bits as the width of the outgoing data stream starting from the located align position. Preferably, the shift register moves its contents per clock by as many bits as the width of said outgoing data stream. In a preferred embodiment, the device further comprises a demultiplexing unit for composing a data stream of a higher width than the incoming data stream.

The method according to the present invention comprises the steps of storing at least one bit times the width of the outgoing data stream, locating a particular bit position indicative of an align position, and outputting the outgoing data stream. Furthermore, data of at least two times the width of the outgoing data stream are stored in a shift register and as many bits as the width of the outgoing data stream starting from the located align position are forwarded to the outgoing data stream.

According to the principle of the present invention the alignment of the incoming data stream can advantageously be performed by using a lower clock rate than the clock rate of the incoming data stream. Furthermore, while aligning the incoming data a parallel data stream of a larger width is formed for further processing.

### BRIEF DESCRIPTION OF THE SEVERAL VIEWS OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows a diagram illustrating the flow of data according to the present invention; and

FIG. 2 shows a block diagram of a device for creating an aligned outgoing data stream of a predetermined width and clock rate from an unaligned incoming data stream according to the present invention.

### DETAILED DESCRIPTION OF THE INVENTION

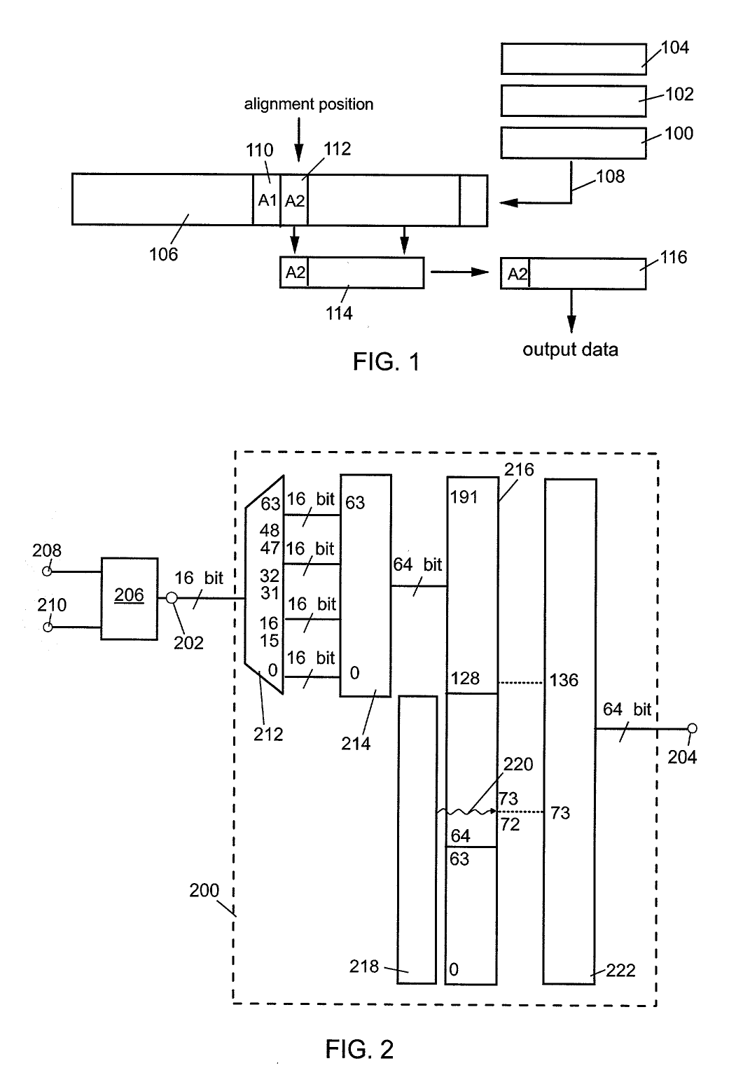

With reference to FIG. 1, there is depicted a diagram illustrating the flow of data according to the present invention. Although the present invention is applicable to all serial or parallel unaligned incoming data streams for creating an aligned outgoing data stream of a predetermined width and clock rate, the present invention will in the following exemplary be described by means of a STM-64 (OC-192) data stream. This is to show that the concept of the present invention is advantageously suitable for realizing high speed frame byte alignment units using state of the art semiconductor technology. The STM-64 level as defined by the SDH/SONET standard operates with a data rate of 9.95 Gb/s.

In a first step the unaligned incoming data stream is deseralized and transformed into a 16-bit parallel data stream. This can, e.g., be done by a state of the art deserializer or by using a PLL (Phase Locked Loop) for extracting the bit clock from the serial data stream and a 16-bit shift register connected to a 16-bit latch in order to form a 16-bit parallel data stream. However, the present invention can be realized either with a single bit serial incoming data steam or a N-bit parallel incoming data stream, whereby N denotes an integer number, preferably an integer number being a power of two, such as 2, 4, 8, 16 etc.

From such a deserializer a 16-bit parallel data stream having a clock rate of 622 MHz is available. Next, e.g., a 1:4 demultiplexer may be integrated which changes the data path width from 16-bit to 64-bit and at the same time reduces the clock rate to 155 MHz. Having to deal with a data stream at that clock rate is feasible with state of the art semiconductor technology even for complicated logic units. It is acknowledged that the deserializer may in one step producing a parallel data stream of a width and clock rate suitable for further processing. However, since suitable deserializer outputting a 16-bit parallel unaligned data stream are available, it might be more efficient to provide an addition demultiplexing unit.

In FIG. 1 the rectangles 100 to 104 represent a first, a second and a third 64-bit data unit of the deserialized and demultiplexed unaligned data stream. It should be noted that the resulting 64-bit data stream is still unaligned with respect to the SDH frame.

In a next step the incoming 64-bit data units 100 to 104 are pipelined by three clock cycles and stored in a 192-bit register 106 as depicted by arrow 108. This is realized by shifting the contents of the 192-bit register by 64 bits every clock cycle and filling the lower portion of the 192-bit register with the next incoming 64-bit data unit. Somewhere in the 192-bit portion of the data stream the alignment position might be. The alignment position is, e.g., marked by a particular pattern like, e.g., three A1 bytes 110 followed by three A2 bytes 112, whereby A1 bytes and A2 bytes are specifically defined bytes in the SDH/SONET standard indicative of the beginning of a new frame.

The search for the change from A1 bytes to A2 bytes in the SDH frame recognition pattern is performed by a align position detection unit (not shown). This operation is done in one specific state of a finite state machine, e.g., the “hunt” state. When the pattern and, therefore, the alignment position is found, the finite state machine switches to a state “sync”. Subsequently, a 64-bit data portion 114 starting with the first bit of the first A2 byte outputted as illustrated by a 64-bit data portion 116. In the following, the same sequence of bits from the register will be send as output from now on with every clock cycle.

An alignment control unit continuously checks whether the A1-A2 pattern repeats in the correct time sequence, i.e., every 125 microseconds in the SDH/SONET case. In case of several consecutive errors the alignment unit is reset into the “hunt” state to search again for the A1-A2 byte pattern. The alignment control unit uses an alignment pulse provided by the alignment unit for its synchronization.

With reference to FIG. 2, there is depicted a block diagram of a device for creating an aligned outgoing data stream of a predetermined width and clock rate from an unaligned incoming data stream according to the present invention, also referred to as byte alignment unit 200. The byte alignment unit 200 receives an unaligned data stream via an input port 202. The inputted data stream has a width of 16 bits. An aligned data stream having a width of 64 bits is outputted by an output port 204.

The incoming unaligned 16-bit data stream may be generated by a deserializer 206 having a first input terminal 208 and a second input terminal 210. The first input terminal 208 receives a serial bit stream, whereas the second input terminal 210 receives a bit clock derived from the incoming serial bit stream.

The alignment unit 200 further comprises a demultiplexing unit 212 for converting the 16-bit data stream received through the input port 202 into a parallel 64-bit data stream having now a quarter of the clock rate in comparison to the 16-bit data stream. The 64-bit data stream is latched by a 64-bit register 214 and forwarded to a storage unit formed by a 192-bit shift register 216. The contents of the 192-bit shift register 216 is monitored by an align position detection unit 218. The align position detection unit 218 locates the specified bit pattern indicating the beginning of a new frame as illustrated by arrow 220. In the shown example the alignment position is located between bit 72 and bit 73 of the 192 bits stored in the 192-bit shift register 216. Such information is forwarded to an extracting unit 222 that extracts a 64-bit portion of the stored 192 bit, i.e., the portion starting from bit 73 to bit 136, and forwards it to the output port 204.

The alignment unit 200 first reads the unaligned incoming data stream that is deserialized by the deserializer 206 having a 16-bit width. Then, the incoming data stream is converted from an 16-bit wide data stream into an 4 times 16-bit wide, i.e., a 64-bit wide, data stream.

Subsequently, data of three times the width of the outgoing data stream are stored in a shift register 216. However, depending on the alignment pattern a smaller portion, but at least two times the width of the outgoing data stream, may be sufficient. In the stored data a particular bit position indicative of an align position is located. After locating the align position 220, the located align position is communicated to the extracting unit 222. For the detection of the align position preferably the data portion positioned at the end of said shift register 216 being located in shift direction is read.

In the following as many bits as the width of the outgoing data stream, i.e., 64 bits, starting from the located align position are outputted. In order to continuously fill the shift register 216, the contents is moved per clock by as many bits as the width of said outgoing data stream, i.e., 64 bits. In the present case the shift register 216 stores as many data as three times the width of the outgoing data stream, i.e., 192 bits.

1. A device for creating an aligned outgoing data stream of a predetermined width and clock rate from an unaligned incoming data stream, the device comprising:
a storage unit for storing at least one bit times the width of the outgoing data stream,
an align position detection unit for locating a particular bit position indicative of an align position, and
an output port for outputting the outgoing data stream,
characterized in that
said storage unit is formed by a shift register providing storage space for at least two times the width of the outgoing data stream and
an extracting unit is provided for forwarding as many bits as the width of the outgoing data stream starting from the located align position.

2. The device according to claim 1, wherein said shift register moves its contents per clock by as many bits as the width of said outgoing data stream.

3. The device according to claim 1, wherein said shift register provides storage space for three times the width of the outgoing data stream.

4. The device according to one of the preceding claims, wherein said align position detection unit is connected to said shift register for reading the stored portion of the data stream and to said extracting unit for transmitting the located align position.

5. The device according to one of the preceding claims, wherein said align position detection unit is configured to read at least as many bits from said shift register as the width of the outgoing data stream.

6. The device according to claim 5, wherein said align position detection unit is configured to read two times as many bits from said shift register as the width of the outgoing data stream.

7. The device according to claim 4, wherein said align position detection is positioned at the end of said shift register being in the shift direction.

8. The device according to one of the preceding claims, wherein said extracting unit is configured to read any the width of the outgoing data stream wide portion of the stored data.

9. The device according to one of the preceding claims, further comprising a demultiplexing unit for composing a data stream of a higher width than the incoming data stream.

10. The device according to claim 9, wherein said demultiplexing unit converts an x bit wide data stream into an n times x bit wide data stream.

11. The device according to one of the preceding claims, wherein said device is configured to read an unaligned incoming data stream that is deserialized having a predetermined width.

12. A method for creating an aligned outgoing data stream of a predetermined width and clock rate from an unaligned incoming data stream, the method comprising the steps of:
storing at least one bit times the width of the outgoing data stream,
locating a particular bit position indicative of an align position, and
outputting the outgoing data stream,
characterized by the step of
storing data of at least two times the width of the outgoing data stream in a shift register and
forwarding as many bits as the width of the outgoing data stream starting from the located align position.

13. The method according to claim 12, wherein said data stored in said shift register (216) are moved clock by as many bits as the width of said outgoing data stream.

14. The method according to claim 12, wherein the step of storing data in said shift register includes storing of as many data as three times the width of the outgoing data stream.

15. The method according to one of the claim 12, wherein the step of locating a particular bit position includes the steps of reading the stored portion of the data stream and transmitting the located align position to said extracting unit.

16. The method according to one of the claims 12, wherein the step of locating a particular bit position includes the step of reading at least as many bits from said shift register as the width of the outgoing data stream.

17. The method according to claim 16, wherein the step of locating a particular bit position includes the step of reading two times as many bits from said shift register as the width of the outgoing data stream.

18. The method according to claim 16, wherein the step of locating a particular bit position includes the step of reading the data portion positioned at the end of said shift register being located in shift direction.

19. The method according to one of the claim 12, wherein said extracting unit (222) is configured to read any the width of the outgoing data stream wide portion of the stored data.

20. The method according to one of the claim 12, further comprising the step of composing a data stream of a higher width than the incoming data stream.

21. The method according to claim 20, wherein the step of composing a data stream of a higher width includes the step of converting an x bit wide data stream into an n times x bit wide data stream.

22. The method according to one of the claims 12 to 21, further comprising the step of reading an unaligned incoming data stream that is deserialized having a predetermined width.

23. A program storage device readable by a machine, tangibly embodying a program of instructions executable by the machine to perform method steps for creating an aligned outgoing data stream,
locating a particular bit position indicative of an align position, and
outputting the outgoing data stream,
characterized by the step of
storing data of at least two time the width of the outgoing data steam in a shift register and
forwarding as many bits as the width of the outgoing data stream starting from the located align position.
